(19) United States
(12) Patent Application Publication
(10) Pub. No.: US 2024/0011703 A1
(43) Pub. Date: Jan. 11, 2024

(54) REFRIGERATOR APPLIANCE AND THERMAL ASSESSMENT SYSTEM

(71) Applicant: Haier US Appliance Solutions, Inc., Wilmington (DE)

(72) Inventors: Michael Goodman Schroeder, Crestwood, KY (US); Brent Alden Junge, Louisville, KY (US)

(21) Appl. No.: 17/861,574

(22) Filed: Jul. 11, 2022

(51) Int. Cl. F25D 29/00

(52) U.S. Cl. CPC F25D 29/00; F25D 2700/16; G01J 2005/0077

(57) ABSTRACT

A refrigeration appliance and method for operation are provided. The refrigeration appliance includes a cabinet forming a refrigeration chamber. One or more of a shelf or a drawer is mounted within the refrigeration chamber and configured to retain a foodstuff. A sensor is positioned in the refrigeration chamber, the sensor configured with a field of view toward the shelf or the drawer. The sensor is configured to obtain a temperature measurement at the field of view. A controller is configured in operable communication with the sensor. The controller is configured to determine thermal mass of the foodstuff over a period of time.

### FIELD

The present subject matter relates generally to refrigerator appliances, and more particularly to refrigerator appliances having thermal determination systems and methods.

### BACKGROUND

Refrigerator appliances stores foods and other others that may vary in quantity or quality over time. Such variation can lead to questionable edibility or spoilage, which if consumed, may be harmful to a user. Accordingly, systems and methods for determining the quality of food and items in the refrigeration appliance are desired and would be advantageous.

### BRIEF DESCRIPTION

Aspects and advantages of the invention will be set forth in part in the following description, or may be obvious from the description, or may be learned through practice of the invention.

An aspect of the present disclosure is directed to a refrigeration appliance and method for operation. The refrigeration appliance includes a cabinet forming a refrigeration chamber. One or more of a shelf or a drawer is mounted within the refrigeration chamber and configured to retain a foodstuff. A sensor is positioned in the refrigeration chamber, the sensor configured with a field of view toward the shelf or the drawer. The sensor is configured to obtain a temperature measurement at the field of view. A controller is configured in operable communication with the sensor. The controller is configured to determine thermal mass of the foodstuff over a period of time.

Another aspect of the present disclosure is directed to a controller for a refrigeration appliance. The controller includes a memory device and a processor, wherein the memory device is configured to store instructions that, when executed by the processor, causes the refrigeration appliance to perform operations. The operations include determining a thermal mass of the foodstuff over a period of time.

Yet another aspect of the present disclosure is directed to a method for operating an appliance. The method includes determining, via a thermal imaging sensor, a thermal mass of foodstuffs at a refrigeration chamber within a field of view of the thermal imaging sensor over a period of time.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of an appliance in accordance with aspects of the present disclosure;

FIG. 2 provides a perspective view of an embodiment of an interior of the appliance of FIG. 1 in accordance with aspects of the present disclosure;

FIG. 3 provides a perspective view of an embodiment of an interior of the appliance of FIG. 1 in accordance with aspects of the present disclosure;

FIG. 4 provides a front, elevation view of the appliance with doors open in accordance with aspects of the present disclosure; and

FIG. 5 provides a schematic flowchart outlining steps of a method for operating an appliance in accordance with aspects of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

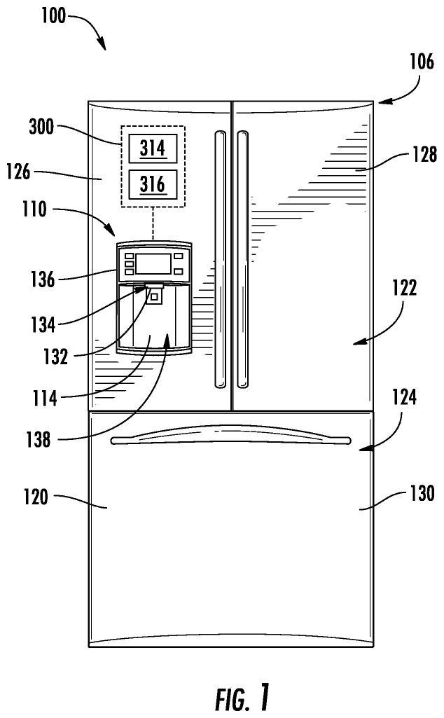

Referring now to the figures, FIG. 1 depicts a front view of an example embodiment of an appliance 100. The appliance 100 may particularly form a refrigerator appliance. The appliance 100 may include a cabinet or housing 120 defining an upper refrigeration chamber 122 and a lower freezer chamber 124 arranged below the refrigeration chamber 122. As such, appliance 100 may generally be referred to as a bottom-mount refrigerator appliance. In the exemplary embodiment, housing 120 also defines a mechanical compartment (not shown) for receipt of a sealed cooling system. Using the teachings disclosed herein, one of skill in the art will understand that the present disclosure may be used with other types of refrigerator appliances (e.g., side-by-sides or top-mounts) or freezer appliances, or other appropriate appliances. Accordingly, the description set forth herein is for illustrative purposes only and is not intended to limit the invention to any particular style or arrangement of refrigeration or freezer appliance.

Refrigerator doors 126, 128 are rotatably hinged to an edge of housing 120 for accessing refrigeration chamber 122. A freezer door 130 is arranged below refrigerator doors 126, 128 for accessing freezer chamber 124. In the exemplary embodiment, freezer door 130 is coupled to a freezer drawer (not shown) slidably mounted within freezer chamber 124.

Appliance 100 may include a dispensing assembly 110 for dispensing liquid water and ice. Dispensing assembly 110 includes a dispenser 114 positioned on an exterior portion of appliance 100. Dispenser 114 includes a discharging outlet 134 for accessing ice and liquid water. A user interface panel 136 is provided for controlling the mode of operation of the dispenser 114, such as for providing water, ice, or a type of type (e.g., crushed, non-crushed, cubed, clear, etc.).

Discharging outlet 134 is an external part of dispenser 114, and is mounted in a dispensing recess or recessed portion 138 defined in an outside surface of refrigerator door 126. Recessed portion 138 is positioned at a predetermined elevation convenient for a user to access ice or liquid water and enabling the user to access ice or liquid water without the need to bend-over and without the need to access freezer chamber 124. In the exemplary embodiment, recessed portion 138 is positioned at a level that approximates the chest level of a user. However, in other embodiments, the dispensing assembly 110 may be positioned within the appliance 100, such as within a chilled chamber thereof.

Operation of the appliance 100 is regulated by a control device or controller 300 that is operatively coupled to user interface panel 136, sensor 230, or both. The controller 300 may include one or more processors 314 and one or more memory devices 316. The one or more memory devices 316 may be configured to store instructions that, when executed by the one or more processors 314, causes the appliance 100 to perform operations such as provided below. The memory device(s) 316 may be configured to store data corresponding to one or more signals, functions, charts, tables, schedules, or determined values such as provided herein.

Panel 136 provides selections for user manipulation of the operation of appliance 100 such as e.g., selections between whole or crushed ice, chilled liquid water, or other options. In response to user manipulation of the user interface panel 136, the controller 300 operates various components of the appliance 100. The controller 300 may be positioned in a variety of locations throughout appliance 100. In the illustrated embodiment shown in FIG. 1, the controller 300 is located within or beneath the user interface panel 136 on door 126. In such an embodiment, input/output (“I/O”) signals may be routed between controller 300 and various operational components of appliance 100. In one exemplary embodiment, the user interface panel 136 may represent a general purpose I/O (“GPIO”) device or functional block. In another exemplary embodiment, the user interface 136 may include input components, such as one or more of a variety of electrical, mechanical or electro-mechanical input devices including rotary dials, push buttons, and touch pads. The user interface 136 may be in communication with the controller 300 via one or more signal lines or shared communication busses, such as described further herein.

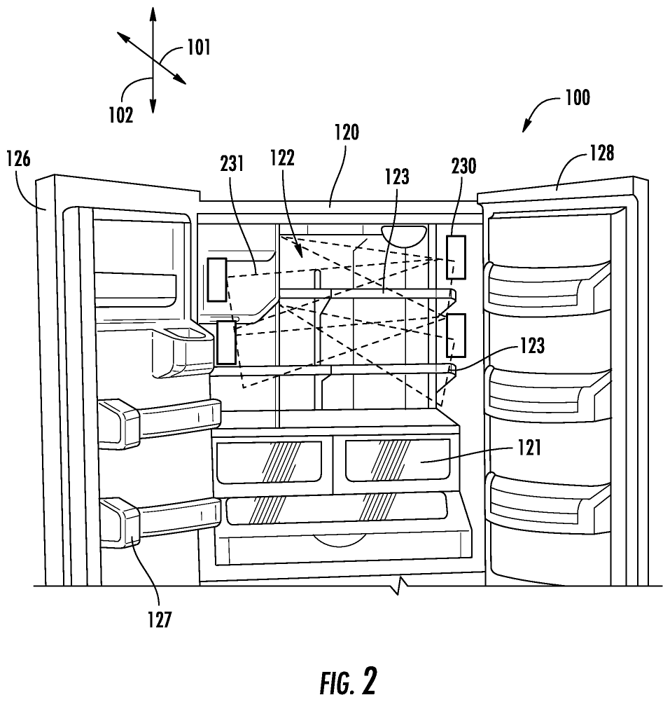

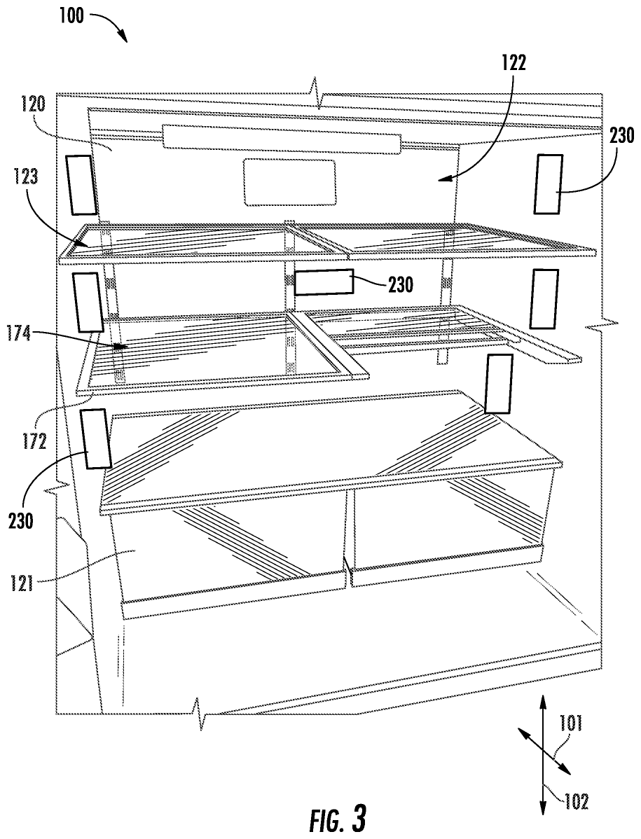

Referring now to FIGS. 2-3, perspective views of an exemplary embodiment of the appliance 100 with doors 126, 128 open is provided, providing a view of an exemplary embodiment of an interior or refrigeration chamber 122. A reference first axis 101 defines a direction into and out of the refrigeration chamber 122. A reference second axis 102 defines a vertical direction. The refrigeration chamber 122 includes a plurality of shelves and drawers positioned within the refrigeration chamber 122. Shelves may include door-mounted shelves 127 positioned at one or both of doors 126, 128 and rack-mounted shelves 123 retained by an interior portion of the housing 120. Drawers 121 may be in sliding configuration and positioned below or between shelves 123, such as along the first axis 101. Shelves 123, 127 and drawers 121 are configured to hold, store, position, or otherwise retain foodstuffs upon surfaces at respective shelves 123, 127 or within compartments or volumes formed by drawers 121.

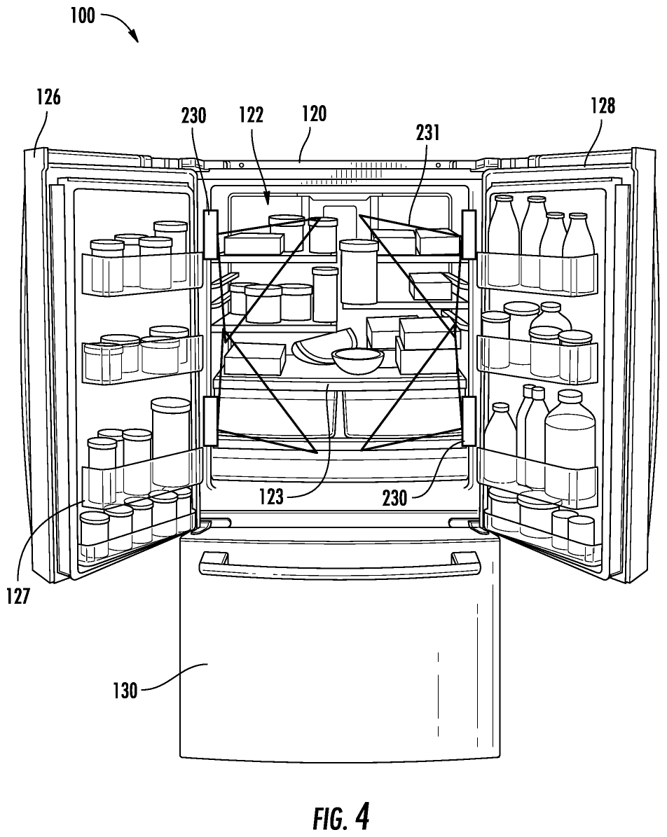

Referring now to FIG. 4, a front, elevation view of the appliance 100 with doors 126, 128 open is provided. FIG. 4 provides a view into refrigeration chamber 122 and depicts an exemplary embodiment of foodstuffs positioned at shelves 123, 127 and within drawers 121. Referring to FIGS. 2-4, appliance 100 includes a sensor 230 positioned in the refrigeration chamber 122. Sensor 230 is configured with a field of view toward the shelf 123, 127 or the drawer 121, such as depicted schematically via lines 231. Sensor 230 is configured to monitor, measure, calculate, or otherwise obtain a temperature measurement within the field of view 231. In particular embodiments, sensor 230 is an imaging device configured to obtain the temperature measurement, such as a thermographic camera, a thermal imaging camera, a thermal imager, or an infrared camera. In various embodiments, sensor 230 may generally include any appropriate measurement instrument configured to obtain a temperature measurement or corresponding data within a field of view or area. The sensor 230 may furthermore generally include any appropriate measurement instrument configured to obtain data, such as imaging data, from wavelengths within approximately 1000 nanometers to approximately 14000 nanometers.

As depicted schematically in FIG. 1, appliance 100 includes a controller 300 configured in operable communication with sensor 230 (FIGS. 2-4). Controller 300 may include a memory device(e.g., non-transitive storage media) and microprocessor, such as a general or special purpose microprocessor operable to execute programming instructions or micro-control code associated with a cleaning cycle. The memory device may represent random access memory such as DRAM, or read only memory such as ROM or FLASH. In one embodiment, the processor executes programming instructions stored in memory. The memory device may be a separate component from the processor or may be included onboard within the processor. Alternatively, controller 300 may be constructed without using a microprocessor, e.g., using a combination of discrete analog or digital logic circuitry (such as switches, amplifiers, integrators, comparators, flip-flops, AND gates, and the like) to perform control functionality instead of relying upon software. Sensor 230 may be in communication with controller 300 via one or more signal lines or shared communication busses. User interface panel 136 may be in communication (e.g., wired or wireless communication) with controller 300 via one or more suitable shared networks.

It should be appreciated that communications busses and secondary devices may correspond to any device that may be programmed to communicate controller 300 using one of Wi-Fi, Bluetooth® , ZigBee®, or similar type of wireless communications technologies and networks while running a program that provides for user input. In this context, devices such as, but not limited to, smartphones, tablet devices, and standalone devices may be used to implement the present subject matter.

Referring to FIGS. 1-4, controller 300 is configured to determine thermal mass of foodstuff at the refrigeration chamber 122 over a period of time. In particular embodiments, sensor 230 is positioned or angled toward one or more shelves 123, 127 or drawers 121, such as to monitor or observe foodstuffs or other items positioned at the shelf or drawer. During an exemplary embodiment of a method for operating an appliance, sensor 230 generates a grid of temperature measurements. In certain embodiments, the grid corresponds to the field of view 231, or particularly to the field of view 231 at shelf surfaces or drawer volumes. Controller 300, via sensor 230, obtains a plurality of temperature decay measurements over the period of time. For instance, obtaining the plurality of temperature decay measurements may include obtaining a plurality of thermal images at the field of view, or grid portions within the field of view. Controller 300 compares the plurality of temperature decay measurements to one another over the period of time. In particular embodiments, controller 300 generates a thermal zone, or plurality of thermal zones, correlating the plurality of temperature decay measurements to the field of view, or particular areas, segments, or portions of the grid or field of view.

Controller 300 may store a table, chart, schedule, graph, plot, or other dataset of thermal coefficient or plurality of thermal coefficients. The thermal coefficient may include a heat transfer coefficient forming a rate of heat transfer from the foodstuff to the air surrounding the foodstuff in the refrigeration chamber 122 per unit surface area per unit temperature difference. The thermal coefficient may particularly include a convection coefficient between the foodstuff and surrounding air in the refrigeration chamber 122. The plurality of temperature decay measurements obtained over the period of time are correlated to the field of view 231, or particular portions of the field of view, to generate the plurality of thermal zones. Controller 300 may further compare the plurality of thermal zones to the thermal coefficient and perform a trend analysis of the thermal over the period of time.

In certain embodiments, an initial period of time (e.g., time=0) may form an initial placement of the foodstuff in the refrigeration chamber 122, or particularly within the field of view 231. Subsequent points in time (e.g., time=n) may correspond to acquisitions of thermal images of the foodstuffs or other items from sensor 230 within the grid or field of view 231. Thermal coefficients may be calculated, estimated, measured, or otherwise determined based at least on position at the grid or field of view 231 and data corresponding to cooling states and obstruction levels. The cooling state may include a first operating mode of the appliance 100 in which a fan, a compressor, or other cooling device is operating to provide or flow cooling fluid (e.g., cool air) in thermal communication with the refrigeration chamber 122. Accordingly, the thermal coefficient is greater then a second operating mode of the appliance 100 in which cooling devices are non-operating. The obstruction level may correspond to an amount, volume, or density of items or other foodstuffs positioned in the grid or field of view. Greater levels of density of items in the grid may correspond to decreased thermal coefficients in contrast to lower levels of density of items in the grid. Still further thermal coefficients may be adjusted or modified based on the thermal zone. In various embodiments, foodstuffs or items positioned in drawers 121, or near cooling devices, or distal to cooling devices, may each include separate thermal coefficients.

In certain embodiments, controller 300 is configured to compare a thermal image to an image library and determine whether the thermal image corresponds to a solid, a liquid, a plasma, or combination thereof. The image library includes a corresponding offset coefficient based on the determination of the solid, liquid, plasma, or combination thereof, or of particular foodstuffs. Controller 300 may utilize the offset coefficient with the thermal mass determination to determine, measure, or estimate an average temperature of the thermal mass. When the image library determines the foodstuff or item is a solid, the offset coefficient may be utilized to estimate an average temperature of the thermal mass. When the image library determines the foodstuff or item is a liquid, the offset coefficient may be one (1) or approximately one (1), such as to provide little or no offset. When the image library does not determine whether the foodstuff or item is solid or liquid, a thermal gradient of a visual space may be assessed, such as via comparing the foodstuff or item to the surrounding air and comparing the thermal gradient between the surrounding air and the foodstuff or item to a thermal gradient threshold. When the thermal gradient is greater than the thermal gradient threshold, controller 300 determines the foodstuff or item to be substantially a liquid. When the thermal gradient is less than the thermal gradient threshold, controller 300 determines the foodstuff or item to be substantially a solid.

In various embodiments, controller 300 is configured to compare a change in thermal mass of the foodstuffs over the period of time to a threshold. Various embodiments of the threshold correspond to any one or more operating methods. In one embodiment, the threshold corresponds to a freshness determination. For instance, changes in thermal mass may be indicative of loss of liquid (e.g., dehydrated foodstuffs) or growth in mold or bacteria. Accordingly, exceeding the threshold may correspond to loss of freshness at the foodstuff.

In another embodiment, the threshold corresponds to de-frosting foodstuffs. For instance, changes in thermal mass may be indicative of change from solid to liquid or loss of liquid (e.g., water draining from meat, poultry, fish, etc. onto a plate at which the foodstuff rests). Accordingly, exceeding the threshold may correspond to de-frosting the foodstuff.

In still another embodiment, the threshold corresponds to power outage at the refrigeration appliance. For instance, changes in thermal mass such as described above, in addition to data corresponding to power outage at the refrigeration appliance, or, additionally or alternatively, fluctuations in temperature at the foodstuff, may correspond to caution, spoilage, or potential hazards at the foodstuffs. For instance, a power outage alone may not result in significant temperature change. Additionally, a power outage resulting in significant temperature change (e.g., temperature increase) may be followed by significant temperature change (e.g., temperature decrease), such as to obscure the change in temperature to a user. Controller 300 may be configured to compare the change in thermal mass of the foodstuffs over the period of time (e.g., the period of time including the power outage), including gaps or step changes in thermal mass resulting from differences due to the power outage. Accordingly, exceeding the threshold may correspond to warning, cautionary, or potentially hazardous conditions at the foodstuff.

In still yet another embodiment, the threshold corresponds to low contents at the foodstuff. For instance, the change in thermal mass may correspond to loss of contents (e.g., usage by a user) at the foodstuffs. The threshold corresponding to low contents, freshness, de-frosting, or power outage may distinguish from one another based at least on differences in the period of time over which the thermal mass changed, or the magnitude of change in thermal mass, or both.

In particular embodiments, controller 300 is further configured to generate a control signal when the threshold is exceeded. It should be appreciated that the threshold may include any one or more separate thresholds such as described above, and the control signal may include any one or more separate control signals corresponding to the separate thresholds. Controller 300 may further be configured to transmit the control signal to the user interface panel 136 operably coupled to the controller 300. The control signal may include a visual signal, audio signal, or combination thereof, configured to indicate to a user the threshold is exceeded, such as described above. The control signal may particularly indicate to the user a position, location, coordinate, grid, sector, or visual representation (e.g., map, image, etc.) corresponding to the foodstuff for which the control signal is generated.

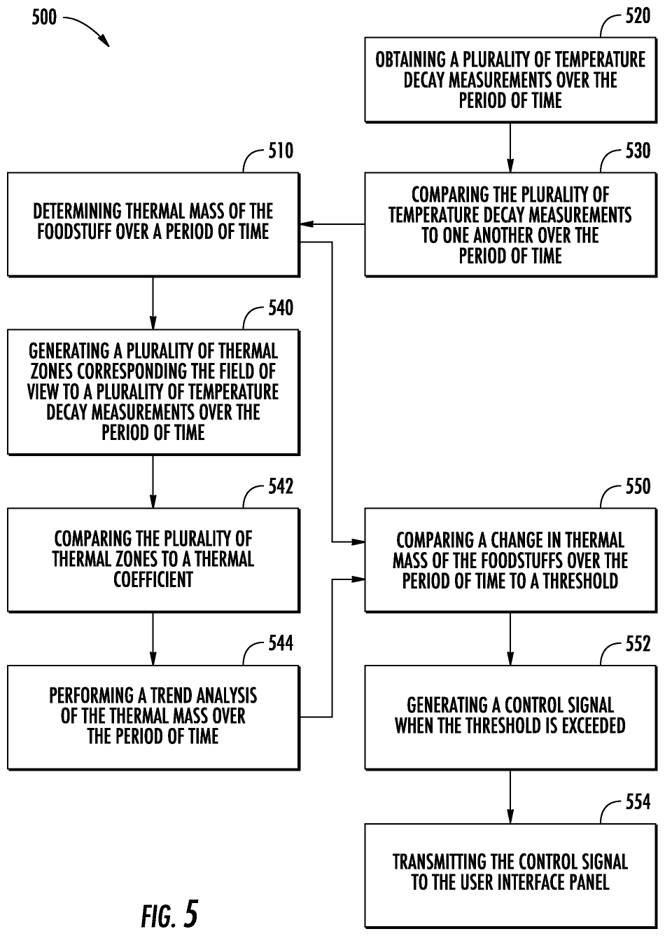

Referring now to FIG. 5, a flowchart outlining steps of a method for operating a refrigeration appliance is provided (hereinafter, “method 500”). Embodiments of method 500 include methods at a refrigeration appliance for determining freshness or spoilage of foodstuffs, methods for determining de-frosting of foodstuffs, methods for determining power outage, or methods for determining low contents of foodstuffs. Steps of method 500 may be stored in memory device 316 as instructions that, when executed by processor 314, causes the appliance 100 to perform operations, such as outlined in one or more steps of method 500. It should be appreciated that while method 500 may be depicted and described in regard to certain embodiments of appliance 100 such as provided and described in regard to FIGS. 1-4, embodiments of method 500 may be executed at any appropriate refrigeration or freezer appliance having a thermal sensor positioned with a field of view in a chamber, such as described in regard to sensor 230, field of view 231, and chamber 122.

Method 500 includes at 510 determining thermal mass of the foodstuff over a period of time. In various embodiments, method 500 includes at 520 obtaining a plurality of temperature decay measurements over the period of time, and at 530 comparing the plurality of temperature decay measurements to one another over the period of time.

In certain embodiments, method 500 includes at 540 generating a plurality of thermal zones corresponding the field of view to a plurality of temperature decay measurements over the period of time. In one embodiment, method 500 includes at 542 comparing the plurality of thermal zones to a thermal coefficient, and at 544 performing a trend analysis of the thermal mass over the period of time.

In still certain embodiments, method 500 includes at 550 comparing a change in thermal mass of the foodstuffs over the period of time to a threshold, and at 552 generating a control signal when the threshold is exceeded. In one embodiment, method 500 includes at 554 transmitting the control signal to the user interface panel. In various embodiments, the control signal is indicative of a freshness determination, of a de-frosting foodstuff, of a power outage at the refrigeration appliance, or of low contents at the foodstuffs, or combinations thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigeration appliance, comprising:
a cabinet forming a refrigeration chamber, wherein one or more of a shelf or a drawer is mounted within the refrigeration chamber, the shelf or the drawer configured to retain a foodstuff;
a sensor positioned in the refrigeration chamber, the sensor configured with a field of view toward the shelf or the drawer, the sensor configured to obtain a temperature measurement at the field of view;
a controller configured in operable communication with the sensor, the controller configured to determine thermal mass of the foodstuff over a period of time.

2. The refrigeration appliance of claim 1, wherein the controller configured to determine thermal mass of the foodstuff comprises the controller configured to:
obtain a plurality of temperature decay measurements over the period of time; and
compare the plurality of temperature decay measurements to one another over the period of time.

3. The refrigeration appliance of claim 1, the controller configured to:
generate a plurality of thermal zones corresponding the field of view to a plurality of temperature decay measurements over the period of time.

4. The refrigeration appliance of claim 3, the controller configured to:
compare the plurality of thermal zones to a thermal coefficient; and
perform a trend analysis of the thermal mass over the period of time.

5. The refrigeration appliance of claim 1, the controller configured to:
compare a change in thermal mass of the foodstuffs over the period of time to a threshold; and
generate a control signal when the threshold is exceeded.

6. The refrigeration appliance of claim 5, the refrigeration appliance comprising:
a user interface panel operably coupled to the controller, wherein the controller is configured to transmit the control signal to the user interface panel.

7. The refrigeration appliance of claim 5, wherein the control signal is indicative of a freshness determination.

8. The refrigeration appliance of claim 5, wherein the control signal is indicative of a de-frosting foodstuff.

9. The refrigeration appliance of claim 5, wherein the control signal is indicative of a power outage at the refrigeration appliance.

10. The refrigeration appliance of claim 5, wherein the control signal is indicative of a low contents at the foodstuff.

11. A controller for a refrigeration appliance, the controller including a memory device and a processor, wherein the memory device is configured to store instructions that, when executed by the processor, causes the refrigeration appliance to perform operations, the operations comprising:
determining a thermal mass of the foodstuff over a period of time.

12. The controller of claim 11, the operations comprising:
obtaining a plurality of temperature decay measurements over the period of time; and
comparing the plurality of temperature decay measurements to one another over the period of time.

13. The controller of claim 11, the operations comprising:
generating a plurality of thermal zones corresponding the field of view to a plurality of temperature decay measurements over the period of time.

14. The controller of claim 13, the operations comprising:
comparing the plurality of thermal zones to a thermal coefficient; and
performing a trend analysis of the thermal mass over the period of time.

15. The controller of claim 11, the operations comprising:
comparing a change in thermal mass of the foodstuffs over the period of time to a threshold; and
generating a control signal when the threshold is exceeded.

15. The controller of claim 15, the operations comprising:
transmitting the control signal to the user interface panel.

16. A method for operating an appliance, the method comprising:
determining, via a thermal imaging sensor, a thermal mass of foodstuffs at a refrigeration chamber within a field of view of the thermal imaging sensor over a period of time.

17. The method of claim 16, the method comprising:
obtaining a plurality of temperature decay measurements over the period of time; and
comparing the plurality of temperature decay measurements to one another over the period of time.

18. The method of claim 16, the method comprising:
generating a plurality of thermal zones corresponding the field of view to a plurality of temperature decay measurements over the period of time.

19. The method of claim 18, the method comprising:
comparing the plurality of thermal zones to a thermal coefficient; and
performing a trend analysis of the thermal mass over the period of time.

20. The method of claim 16, the method comprising:
comparing a change in thermal mass of the foodstuffs over the period of time to a threshold.
